(19) United States
(12) Patent Application Publication
(10) Pub. No.: US 2010/0147236 A1
(43) Pub. Date: Jun. 17, 2010

(54) TANDEM TWIN POWER UNIT ENGINE HAVING AN OSCILLATING CYLINDER

(76) Inventor: Joseph E. Springer, Montclair, CA (US)

Correspondence Address: PATENT VENTURE GROUP, 10788 CIVIC CENTER DRIVE, SUITE 215, RANCHO CUCAMONGA, CA, 91730, US

(21) Appl. No.: 12/711,922

(22) Filed: Feb. 24, 2010

Related U.S. Application Data
(63) Continuation-in-part of application No. 12/055,989, filed on Mar. 26, 2008, now Pat. No. 7,685,975.
(60) Provisional application No. 61/016,454, filed on Dec. 22, 2007.

(51) Int. Cl. F02B 75/20

(52) U.S. Cl. 123/58.8

(57) ABSTRACT

An invention is provided for an internal combustion engine having a trunnion twin firing cylinder put in tandem for application of 4-6-8 cylinders as needed, including three moving parts, cylinder, piston rod, and crank that fires two pistons during up stroke while having a wet sump, cylinders are perpendicular to the crank and are enclosed at the bottom allowing four strokes every revolution with double firing pistons. The pistons do not require a wrist pin, and the pistons and rod assembly are one piece, pushing straight on the crank throw, eliminating piston side thrust, and reducing conical wear to rings with blow by. A conventional four cylinder engine at 1000 rpm fires 4,000 times in one minute. The trunnion twin firing cylinder engine with four pistons fires 8,000 times in one minute.

### CROSS REFERENCE TO RELATED APPLICATIONS

This application is a continuation-in-part of U.S. patent application having Ser. No. 12/055,989, filed on Mar. 26, 2008, entitled “Internal Combustion Engine Twin Power Unit Having An Oscillating Cylinder,” by inventor Joseph E. Springer, which claims the benefit of U.S. Provisional Patent Application having Ser. No. 61/016,454, filed on Dec. 22, 2007, entitled “Internal Combustion Engine Twin Power Unit Having an Oscillating Cylinder,” by inventor Joseph E. Springer, both of which are hereby incorporated by reference.

### BACKGROUND OF THE INVENTION

1. Field of the Invention

This invention relates generally to internal combustion engines, and more particularly to a twin firing oscillating cylinder engine having three moving parts: cylinder, piston-rod, and crank assembly for each tandem.

2. Description of the Related Art

To derive power, conventional internal combustion engines ignite a compressed air-fuel mixture in a combustion chamber. The ignition of the compressed air-fuel mixture generates force against a piston, which is linked to a crankshaft in a manner such that the motion of the piston is converted into rotational motion of a drive shaft. More particularly, in operation air and fuel is provided to a combustion cylinder and compressed by the piston. Once compressed, the air-fuel mixture is ignited powering the piston and the crankshaft. The exhaust is then expelled from the cylinder.

Internal combustion engines generally can be either two-stroke or four-stroke engines. In general, two-stroke engines complete the power cycle during a single reciprocation of the piston, that is, one revolution of the crankshaft. Four-stroke engines generally require two reciprocations of the piston, or two revolutions of the crankshaft. Two-stroke engines offer certain advantages over four-stroke engines because the former produces power strokes twice as often as compared to the four-stroke engine. This permits two-stroke engines to be smaller in size and lighter in weight than four-stroke engines with a comparable power output. Two-stroke engines are also less expensive to manufacture and build because they require fewer parts that are subject to wear, breakdown and replacement.

Conventional two-stroke engines, however, are generally not as efficient as four-stroke engines because two-stroke engines do not effectively remove all of the exhaust gases from the combustion chamber before the next power producing cycle. For example, FIG. 1 is an illustration showing a prior art two-stroke engine 100. The prior art two-stroke engine 100 includes an enclosed crankcase 102 below a cylinder 104 housing a piston 106. The piston 106 is connected to a crankshaft 108 via a crank throw 110 and connecting rod 112. To allow the piston 106 to travel up and down within cylinder 104, the piston 106 is connected to the connecting rod 112 via a wrist pin 114. As illustrated in FIG. 1, in the prior art two-stroke engine 100, both the intake port 116 and the exhaust port 118 are open at the same time to enable the new air-fuel mixture to flow into the combustion chamber and to allow the escape of the exhaust gases. The concurrent opening of the intake port 116 and exhaust port 118 allows the fresh air-fuel mixture to purge the exhaust gases out of the combustion chamber through the exhaust port 118. This is disadvantageous because some of the fresh air-fuel mixture escapes through the exhaust port 118 reducing engine efficiency by failing to utilize all of the fresh air-fuel mixture during the combination process. In addition, some of the exhaust gases mix with the incoming fresh air-fuel mixture which further reduces engine efficiency because noncombustible gases remain in the combustion chamber during the subsequent power cycle.

Conventional internal combustion engines, including the prior art two-stoke engine 100 illustrated in FIG. 1, also lose power and efficiency because the reciprocating piston 106 is attached to the crankshaft 108 by the connecting rod 112 and the wrist pin 114 to translate linear reciprocating motion of the piston 106 into rotational movement of the crankshaft 108. The use of the connecting rod 112 and wrist pin 114 results in uneven and excessive wear to the piston 106 and cylinder wall because lateral forces are transmitted through the connecting rod 112 in directions other than through the centerline of the piston 106. In a typical engine, the cylinders are held stationary in the engine block and the pistons 106 are connected to the rotating crankshaft 108 by the connecting rod 112 which pivots about the wrist pin 114. When the piston 106 is in any position other than the top dead center or bottom dead center of the cylinder 104, the force acting through the centerline of the piston 106 is not aligned with the axis of rotation of the crankshaft 108. Transverse or lateral force vectors, which cause uneven wear of the piston 106, are created because the force is not acting directly upon the crankshaft 108.

In view of the foregoing, there is a need for an internal combustion engine that does not lose power due to non-alignment of the axis of rotation of the crankshaft and the connecting rod. In addition, the internal combustion engine should prevent wasteful air-fuel mixture escaping the system prior to combustion.

### SUMMARY OF THE INVENTION

Broadly speaking, the present invention addresses these needs by providing an oscillating cylinder twin power unit for an internal combustion engine that can be coupled together in tandem to form engines of varying sizes. Broadly speaking, embodiments of the present invention utilize parallel oscillating cylinders coupled to a rod assembly, which powers a crankshaft without requiring a wrist pin. In addition, a trunnion mount allows the twin power unit to oscillate back and forth across a small arc while tracking the rotational movement of the point of contact between the base on the rod assembly and the crankshaft. The crankshaft is formed by coupling together a plurality of power units via crank coupler assemblies.

For example, in one embodiment a tandem internal combustion engine is disclosed. The tandem internal combustion engine includes a first and second power unit having an enclosed intake cylinder, an enclosed exhaust cylinder and two pistons each disposed within an enclosed cylinder. Each piston compresses air beneath the piston before the compressed air is transferred to the intake cylinder. The power units further each include a main journal attached to a crank coupler. The tandem internal combustion engine also includes a crank coupler assembly in physical communication with the crank couplers of the power units. For example, the crank couplers can have splined shafts and the crank coupler assembly can include a plurality of hardened pins positioned to fit splines of the splined shafts of the crank couplers. To provide additional flexibility each power unit can include a crank assembly comprising two crank halves coupled together via a bolt, with each crank half being attached to a main journal. In this aspect, each crank half further includes a crank throw portion. A sleeve surrounds the crank throw portion of each crank half of a crank assembly, and can include a plurality of keyway pins is disposed within the sleeve, and wherein one keyway pin is attached to the sleeve. To provide fuel savings, the first power unit can be separated from the second power unit when the tandem internal combustion engine is at idle.

An additional tandem internal combustion engine is disclosed in further embodiment. Similar to above, tandem internal combustion engine includes first and second power units each having an enclosed intake cylinder, an enclosed exhaust cylinder and two pistons each disposed within an enclosed cylinder. Each piston compresses air beneath the piston before the compressed air is transferred to the intake cylinder. In addition, each power unit further including a main journal attached to a crank coupler and a crank coupler assembly in physical communication with the crank coupler. A coupling means, such as a belt or chain, is also included that couples the crank coupler assembly of the first power unit to the crank coupler assembly of the second power unit. To control the movement of the pistons, each power unit includes a plurality of cylinder control arms, each including a guide rail portion capable of guiding the movement of the pistons of the power unit during operation. For example, the movement of the pistons of each power unit cam be guided utilizing a rolling means that rolls along the guide rails. Each piston of each power unit can include an internal piston cooling means, such as a tube disposed within each piston that provides oil to an inside of the piston.

In a further embodiment, an additional tandem internal combustion engine disclosed. As above, tandem internal combustion engine includes a first and second power unit having an enclosed intake cylinder, an enclosed exhaust cylinder and two pistons each disposed within an enclosed cylinder. Each piston compresses air beneath the piston before the compressed air is transferred to the intake cylinder. The power units further each include a main journal attached to a crank coupler. In addition, a coupling means is included that is in physical communication with the crank coupler of the first power unit and the crank coupler of the second power unit. For example, the coupling means can be a crank coupler assembly having a plurality of hardened pins disposed to fit splines of the crank couplers. Optionally, each power unit can be capable of being moved relative to the pistons such that a space between a top of the pistons and a top of the cylinders can be varied, thus providing variable compression. Further, each power unit can also include a hot spark plug and a cold spark plug, wherein the hot spark plug has more electrode area exposed than the cold spark plug. In this case, the hot spark plug can be used during idle and the cold spark plug is used during normal running. Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings in which:

FIG. 1 is an illustration showing a prior art two-stroke engine;

FIG. 2A is a diagram showing an oscillating cylinder twin power unit for an internal combustion engine, in accordance with an embodiment of the present invention;

FIG. 2B is a diagram showing an additional embodiment of an oscillating cylinder twin power unit illustrating cylinder control arms for use in guiding the pistons, in accordance with an embodiment of the present invention;

FIG. 3A is a side view of the twin power unit showing the exhaust cylinder, in accordance with an embodiment of the present invention;

FIG. 3B is a top view of a power unit having trunnion mounted fuel injection, in accordance with an embodiment of the present invention;

FIG. 4 is a flowchart showing a method of operation for the oscillating cylinder twin power unit, in accordance with an embodiment of the present invention;

FIG. 5A illustrates a twin power unit during the beginning of a power cycle, in accordance with an embodiment of the present invention;

FIG. 5B illustrates a twin power unit at the beginning of a purge cycle, in accordance with an embodiment of the present invention;

FIG. 5C is a diagram illustrating a twin power unit at the end of a purge cycle, in accordance with an embodiment of the present invention;

FIG. 5D is a diagram showing a twin power unit during a charge cycle, in accordance with an embodiment of the present invention;

FIG. 6 is a diagram showing an oscillating cylinder twin power unit for an internal combustion engine utilizing an exhaust valve and rocker assembly for purging combustion exhaust gases, in accordance with an embodiment of the present invention;

FIG. 7A is schematic diagram illustrating a crank assembly comprising two crank halves, in accordance with an embodiment of the present invention;

FIG. 7B is schematic diagram illustrating a crank throw journal sleeve and supporting keyway pins, in accordance with an embodiment of the present invention;

FIG. 8A is a schematic diagram showing a front view of crank coupler assembly, in accordance with an embodiment of the present invention;

FIG. 8B is a diagram showing splined crank coupler portion from two power units prior to being attached together via the crank coupler assembly, in accordance with an embodiment of the present invention;

FIG. 9A is a diagram showing a side view of an exemplary four-cylinder tandem engine, in accordance with an embodiment of the present invention;

FIG. 9B is a diagram showing a side view of an exemplary eight-cylinder tandem engine, in accordance with an embodiment of the present invention;

FIG. 10A is a diagram showing a top view of an exemplary four-cylinder inline tandem engine, in accordance with an embodiment of the present invention;

FIG. 10B is a diagram showing a top view of an exemplary six-cylinder inline tandem engine, in accordance with an embodiment of the present invention;

FIG. 11A is a diagram showing a side view of an exemplary decoupling four-cylinder tandem engine, in accordance with an embodiment of the present invention;

FIG. 11B is a diagram showing a side view of the exemplary decoupling four-cylinder tandem engine after decoupling, in accordance with an embodiment of the present invention; and

FIG. 12 is a diagram showing an exemplary variable compression power unit having cylinder compression variance capability, in accordance with an embodiment of the present invention.

### DETAILED DESCRIPTION OF THE PREFERRED EMBODIMENTS

An invention is disclosed for providing a twin power unit having an oscillating cylinders for an internal combustion engine. Broadly speaking, embodiments of the present invention utilize parallel oscillating cylinders coupled to a rod assembly, which powers a crankshaft without requiring a wrist pin. In addition, a trunnion mount allows the twin power unit to oscillate back and forth across a small arc while tracking the rotational movement of the point of contact between the base on the rod assembly and the crankshaft. Hence, the trunnion mount allows the twin power unit to oscillate such that the centerline of the pistons is at all times aligned with the crank throw of the crankshaft to eliminate lateral force vectors. Since the rod assembly directly connects the pistons to the crankshaft, there is no need for a wrist pin and connecting rod. Moreover, in one embodiment, a unique enclosed cylinder design is utilized to allow an intake air charge to be compressed beneath the pistons and later blasted into the cylinders above the pistons to purge combustion exhaust gases from the cylinders. As will be appreciated after a careful reading of the present disclosure, the twin power units described below can be utilized alone, or with multiple twin power units connected to the crankshaft.

In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

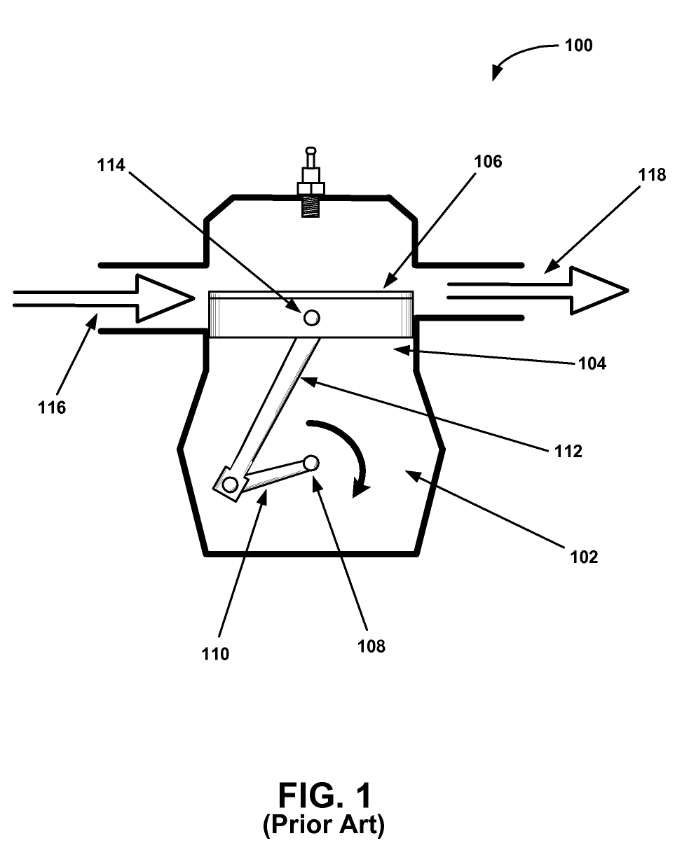

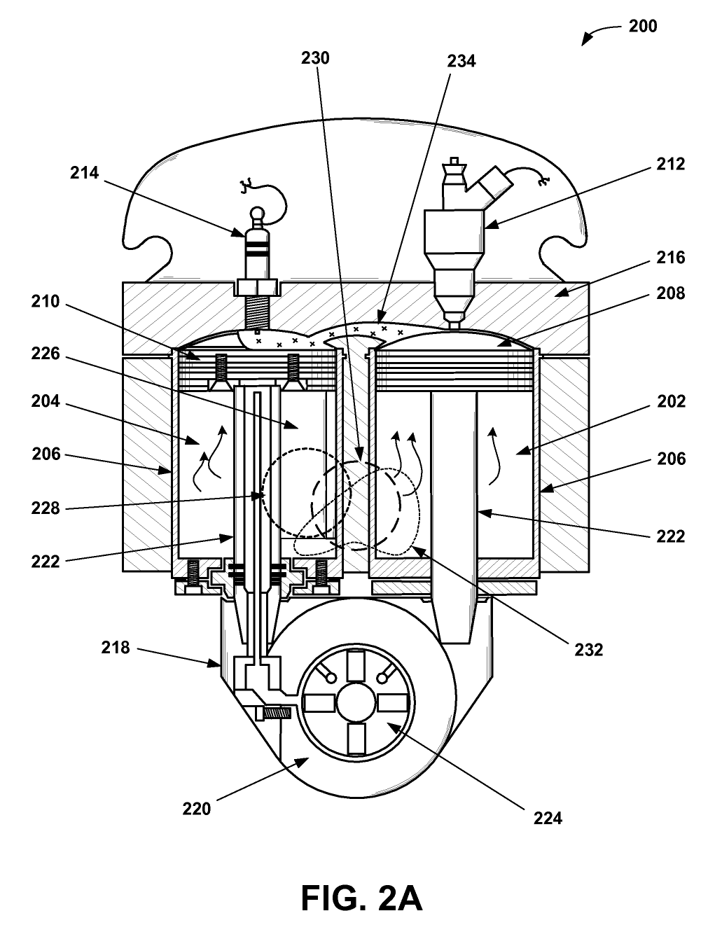

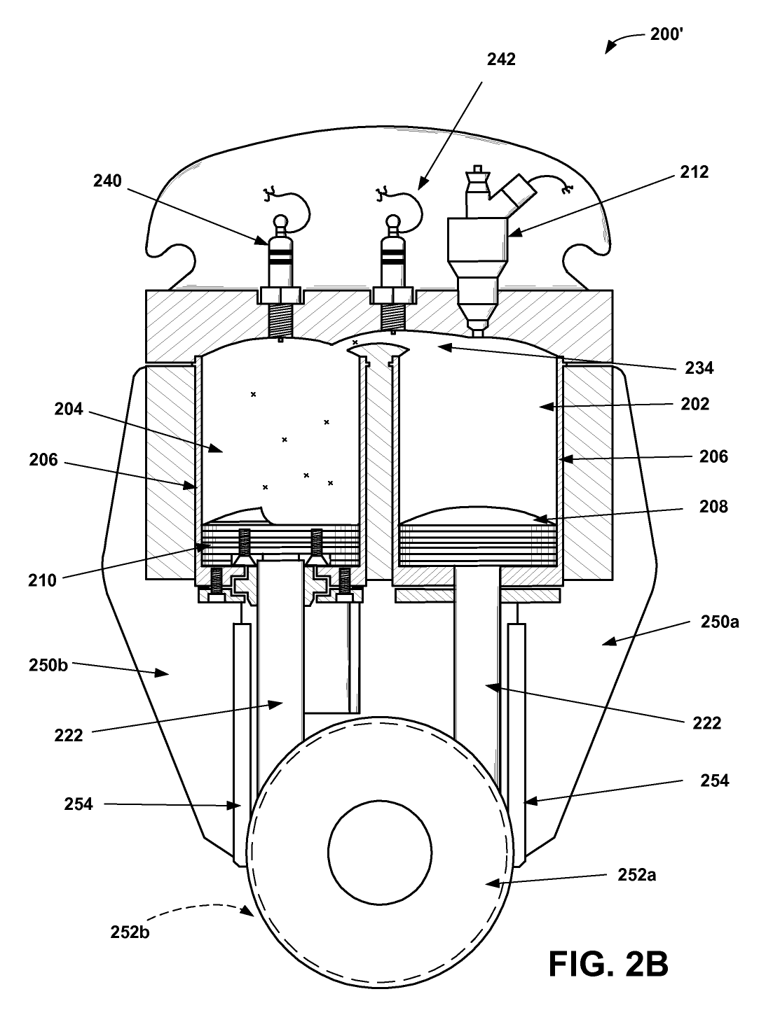

FIG. 1 was described in terms of the prior art. FIG. 2A is a diagram showing an oscillating cylinder twin power unit 200 for an internal combustion engine, in accordance with an embodiment of the present invention. The exemplary twin power unit 200 of FIG. 2A includes an intake cylinder 202 and exhaust cylinder 204, each enclosing a piston sleeve 206. Located in the intake cylinder 202 is an intake piston 208, and disposed in the exhaust cylinder 204 is an exhaust piston 210. An exhaust piston skirt 226 is attached to the exhaust piston 210 to seal the exhaust port during the charge and power cycles as will be described in greater detail subsequently. In the embodiment of FIG. 2A, a fuel injector 212 is situated above the intake cylinder 202 and a spark plug 214 is located above the exhaust cylinder 204, both of which being disposed in the cylinder head base 216. Fixed below the pistons 208 and 210 is a rod assembly 218, which includes a rod base bearing mount 220 connected to two tubular rod assemblies 222, and a crank assembly 224. Also illustrated in FIG. 2A are an exhaust port 228 connected to the exhaust cylinder 204 and an intake port 230 connected to the intake cylinder 202. The intake port 230 also is in fluid communication with an intake charge passage 232 that connects the bottom portions of the intake cylinder 202 and the exhaust cylinder 204. In addition, an air-fuel crossover passage 234 connects the top portions of the intake cylinder 202 and the exhaust cylinder 204. As will be described in greater detail subsequently, the air-fuel crossover passage 234 allows an air-fuel mixture introduced in the intake cylinder 202 to be transferred to the exhaust cylinder 204, and further allows an ignition in any cylinder to cause combustion of the air-fuel mixture in both cylinders.

Embodiments of the present invention provide twin power pistons (i.e., the intake piston 202 and exhaust piston 204) that fire simultaneously to drive a crankshaft via a one piece rod assembly 218, that rigidly fixes the intake piston and exhaust piston in a fixed spatial relation to each other. As will be described in greater detail below, the trunnion mounted cylinders allow the twin power unit 200 to rotate with the one piece rod assembly 218 allowing power transference without the need for a wrist pin. Moreover, the use of fully enclosed cylinders allows an intake charge without the need of an enclosed crankcase, which leads to oil mixing with the intake charge resulting in heavy emissions concerns.

In operation, the twin power unit functions utilizing three cycles: 1) charge cycle, 2) power cycle, and 3) purge cycle. During the charge cycle both the intake piston 208 and the exhaust piston 210 rise within the corresponding cylinders 202 and 204, compressing the air above the cylinders into the top portions of the cylinders 202 and 204. As the pistons 208 and 210 rise, the fuel injector 212 is timed to deliver fuel to the intake cylinder 202 creating an air-fuel mixture. Because the simultaneous compression currently occurring within the top portions of the cylinders 202 and 204, a swirling effect is created mixing the fuel with the compressed air, creating an air-fuel mixture that also flows into the top portion of the exhaust cylinder 204 via the air-fuel crossover passage 234.

In addition, as the intake piston 208 and exhaust piston 210 rise, the pistons move to reveal the intake charge passage 232. The rising movement of the intake piston 208 and exhaust piston 210 draws in an air intake charge from the intake port 230 and through the intake charge passage 232 into the bottom portions of the intake cylinder 202 and exhaust cylinder 204 beneath the pistons 208 and 210. Both the intake cylinder 202 and the exhaust cylinder 204 are fully enclosed, thus preventing the intake air from escaping. In addition, as will be described in greater detail subsequently, during the charge cycle the exhaust port 228 is covered by the exhaust piston skirt 226, preventing the intake air charge from escaping via the exhaust port 228.

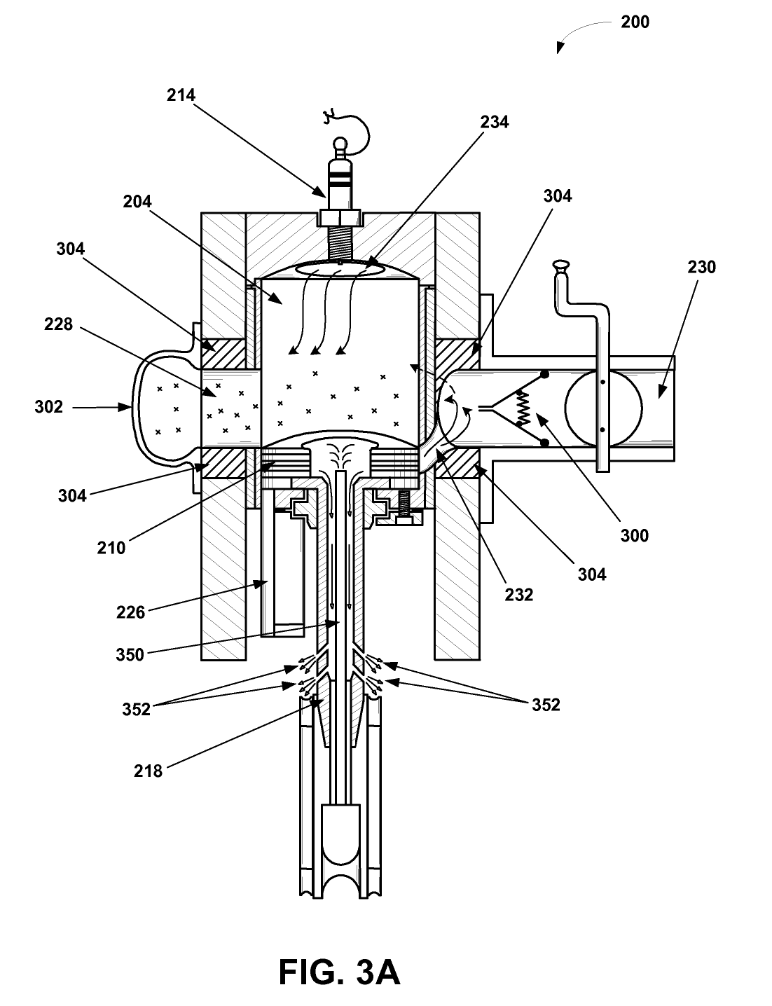

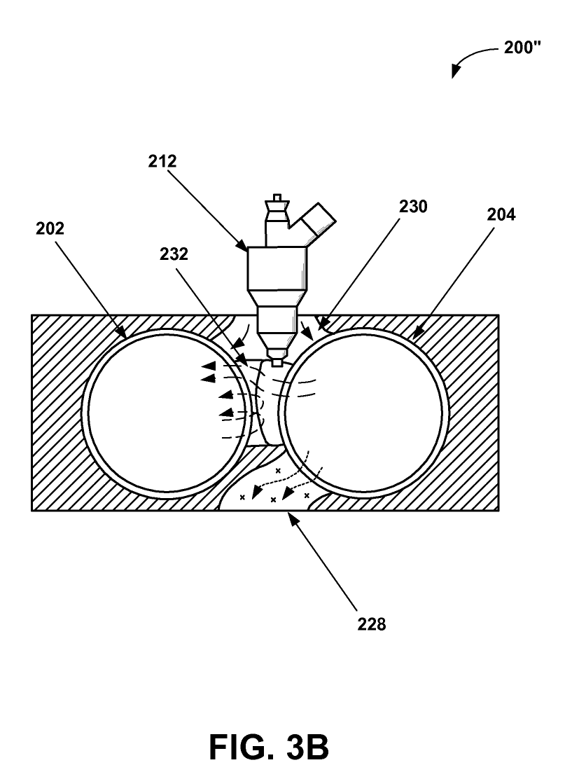

The power cycle begins once the pistons reach the top of the cylinders at 12 o'clock and full compression is achieved. The spark plug 214 ignites the compressed air-fuel mixture powering the pistons 208/210 and driving the pistons 208/210 and rod assembly 218 toward the crankshaft. During full compression, the compressed air-fuel mixture is present in the top portions of both the intake cylinder 202 and the exhaust cylinder 204, and also in air-fuel crossover passage 234. Hence, the spark plug 214 ignites the air-fuel mixture in the exhaust cylinder 202, which ignites the air-fuel mixture in the air-fuel crossover passage 234, which ignites the air-fuel mixture in the intake cylinder 202. As a result, both the exhaust piston 210 and the intake piston 208 are powered during the power cycle via the spark plug 214. As the pistons 208 and 210 travel downward within the cylinders, the pistons 208 and 210 begin to drive the air intake charge currently stored beneath the pistons back into the intake port 230 via the intake charge passage 232, as best depicted in FIG. 3A.

FIG. 3A is a side view of the twin power unit 200 showing the exhaust cylinder 204, in accordance with an embodiment of the present invention. The purge cycle begins as the pistons 208 and 210 travel downward and the exhaust piston 210 begins to clear the exhaust port 228, when the crankshaft reaches about 3:30 and the twin power unit 200 rotates about the trunnion mount 304. As noted above, the downward motion of the pistons 208 and 210 drives the intake air present in both cylinders below the pistons 208 and 210 back into the intake port 230 via the intake charge passage 232. However, a one-way reed valve 300 present in the intake port 230 prevents the intake air from escaping out of the intake port 230. As a result, the downward motion of the pistons 208 and 210 compresses the intake air in the bottom portion of the cylinders 202 and 204 and portion of intake port 230 on the piston side of the reed valve 300.

Once the exhaust piston 210 begins to clear the exhaust port 228, the combustion exhaust gases from the power cycle begin to escape the exhaust cylinder 204 via the exhaust port 228 into the exhaust pipe 302. As the pistons 208 and 210 continue to travel downward, the intake piston 208 begins to reveal the intake charge passage 232. Once the top of the intake piston 208 drops below the top of the intake charge passage 232, the intake charge air compressed beneath the pistons 208 and 210, and in the portion of intake port 230 on the piston side of the reed valve 300, is blasted into the intake cylinder 202 above the intake piston 208.

The rapid intake charge air blast purges the combustion exhaust gases from the intake cylinder 202, through the air-fuel crossover passage 234, through the exhaust cylinder 204, and out the exhaust port 228. As will be appreciated by those skilled in the art after a careful reading of the present disclosure, the rapid intake charge air blast also purges the combustion exhaust gases from the air-fuel crossover passage 234 and the exhaust cylinder 204.

As the intake piston 208 and exhaust piston 210 begin to travel back upward, the intake charge air, forced via the upward motion of the pistons 208 and 210 further expels the combustion exhaust gases from the cylinders 202/204 and air-fuel crossover passage 234 out the exhaust port 228. In addition, another charge cycle begins with the fuel injector 212 delivering fuel to the intake cylinder 202, and the pistons 208/210 rising to reveal the intake charge passage 232, and thereby drawing in another air intake charge into the bottom portions of the intake cylinder 202 and exhaust cylinder 204 beneath the pistons 208 and 210.

To provide cooling for the pistons 202/204, embodiments of the present invention utilize interior piston rod bolt tubes inside each piston to provide oil based piston cooling. For example, in FIG. 3A the exhaust piston 210 is illustrated having an interior piston rod bolt tube 350 disposed within the piston rod 218 of the exhaust piston 210. Oil to cool the piston is provided under pressure from the journal. The oil then travels up the interior piston rod bolt tube 350 to the top of the piston 210 interior, and then down the inside of the piston rod 218. The oil is allowed to exit the piston rod 218 via oil exit passageways 352 connecting the piston rod interior and exterior.

FIG. 2B is a diagram showing an additional embodiment of an oscillating cylinder twin power unit 200′ illustrating cylinder control arms for use in guiding the pistons, in accordance with an embodiment of the present invention. The exemplary twin power unit 200′ of FIG. 2B includes an intake cylinder 202 and an exhaust cylinder 204, each enclosing a piston sleeve 206 and connected via an air-fuel crossover passage 234. Located in the intake cylinder 202 is an intake piston 208, and disposed in the exhaust cylinder 204 is an exhaust piston 210. A fuel injector 212 is situated above the intake cylinder 202. A hot spark plug 240 is located above the exhaust cylinder 204 and a cold spark plug 242 is located above the air-fuel crossover passage 234. Fixed below the pistons 208 and 210 is a rod assembly, which includes a rod base bearing mount and tubular rod assemblies 222.

FIG. 2B illustrates how the pistons 208/210 and rod assembly is guided up and down parallel to a central plane of the twin power unit 200′ via cylinder control arms 250a/250b and racking rollers 252a/252b. In one embodiment, each cylinder control arm 250a/250b is attached to one side of the power unit. For example, in FIG. 2B cylinder control arm 250b is attached to the exhaust cylinder side of the twin power unit 200′ and cylinder control arm 250a is attached to the intake cylinder side of the twin power unit 200′. Each racking roller 252a/252b can be attached to a side of the rod assembly. In one embodiment, each racking roller 252a/252b can be movably coupled to a crank throw portion 708 of the crank assembly on each side of the rod assembly. For example, in FIG. 2B racking roller 252a is attached to one side of the rod assembly (toward the viewer in FIG. 2B) and racking roller 252b is attached to the opposite side of the rod assembly (away from the viewer and obscured from view by racking roller 252a in FIG. 2B).

In one embodiment, each cylinder control arm 250a/250b includes a guide rail 254 fixed such that a racking roller 252a/252b can roll along the guide rail 254 as the rod assembly moves up and down in relation to the cylinders. Hence, in FIG. 2B cylinder control arm 250a is situated such that the guide rail 254 portion of the cylinder control arm 250a is disposed such that the racking roller 252a (attached to the viewable side of the rod assembly in FIG. 2B) can roll against guide rail 254 of cylinder control arm 250a. Similarly, cylinder control arm 250b is situated such that the guide rail 254 portion of the cylinder control arm 250b is disposed such that the racking roller 252b (attached to the non-viewable side of the rod assembly in FIG. 2B) can roll against the guide rail 254 of cylinder control arm 250b.

FIG. 2B also illustrates a spark plug arraignment having a hot spark plug 240 and a cold spark plug 242. As is well known, a spark plug operates to force electricity to arc across a gap, to ignite compressed gases during operation of the power unit. To force a high voltage to travel to the electrode of the spark plug, the spark plug includes an insulated passageway, which is also designed to withstand the extreme heat and pressure present inside the cylinders during operation. In general, spark plugs use a ceramic insert to isolate the high voltage at the electrode, thus ensuring that the spark happens at the tip of the electrode and not anywhere else on the plug. In addition, ceramic generally does not conduct heat well, and as a result functions to protect the spark plug from too much heat during operation.

As mentioned above, the power unit 200′ of FIG. 2B includes both a hot spark plug 240 and a cold spark plug 242. The hot spark plug 240 includes a ceramic insert that has a smaller contact area with the metal part of the plug, thus reducing the heat transfer from the ceramic and making the hot spark plug 240 run hotter and thus burn away more deposits from fuel. When all the fuel in the cylinders is not burned during a burn, the spark plugs have a tendency to carbon up. In the past, the plugs were removed and cleaned with a wire brush to get the carbon off that builds up on the plug. However, the hot plug 240 cleans itself, as described above. But hot plugs do not work well at high speed because at high speed the spark may not be able to jump the gap of the hot spark plug 240, and the hot spark plug 240 has a tendency to get too hot at high speed. Thus, during idle, the hot spark plug 240 is used. During normal running, the cold spark plug 242 is used.

FIG. 3B is a top view of a power unit 200″ having trunnion mounted fuel injection, in accordance with an embodiment of the present invention. As above, the power unit 200″ includes an intake cylinder 202, an exhaust cylinder 204, an intake port 230, an intake charge passage 232, and an exhaust port 228. However, the power unit 200″ includes a fuel injector 212 situated within the intake port 230 so as to release fuel into the intake charge passage 232.

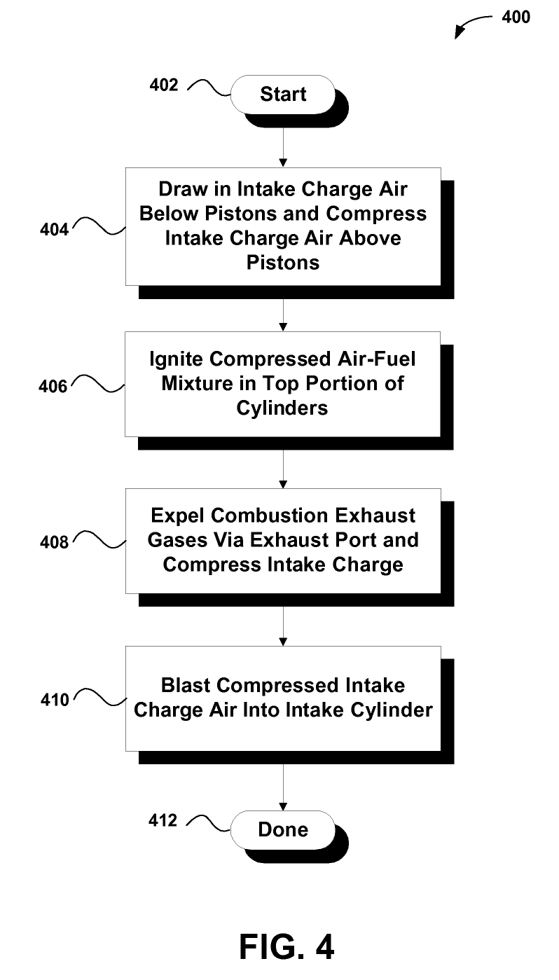

In this manner, when air is forced from beneath the pistons into the top of the cylinders 202/204, as described above, fuel is injected into the air dramatically increasing the swirl effect and air-fuel mixing. In addition, by situating the fuel injector 212 with the intake port, less movement is required of the fuel injector when the engine is running since the fuel injector 212 can remain relatively steady within the trunnion mount. As mentioned above, the trunnion mounted cylinders of the embodiments of the present invention allow the twin power unit 200 to rotate with the one piece rod assembly 218 allowing power transference without the need for a wrist pin using a guide system as illustrated next with reference to FIG. 4.

FIG. 4 is a flowchart showing a method 400 of operation for the oscillating cylinder twin power unit 200, in accordance with an embodiment of the present invention. In an initial operation 402, engine preparation operations can be performed. Engine preparation operations can include, for example, determining the number of twin power units to include in the engine, calculating proper timing for the twin power units according to size and performance needs, and other engine preparation operations that will be apparent to those skilled in the art after a careful reading of the present disclosure.

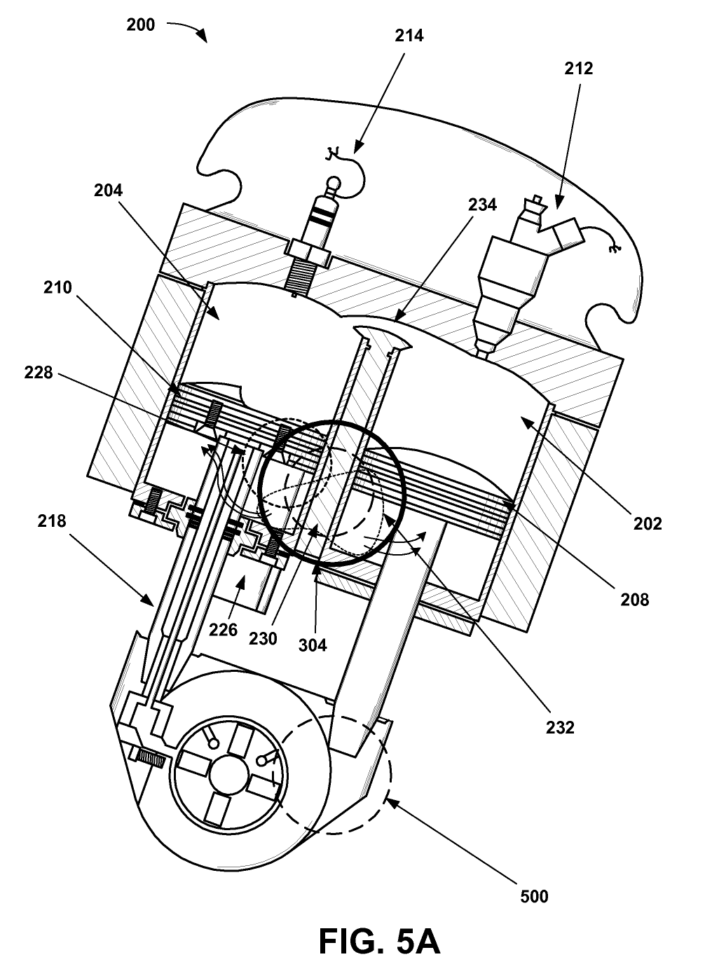

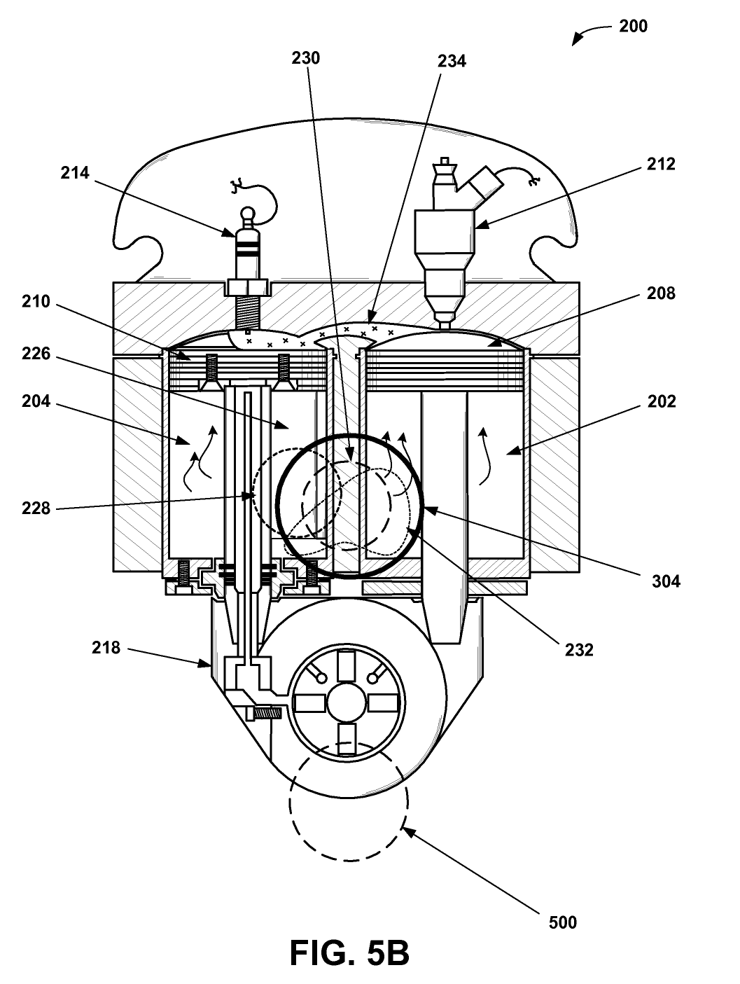

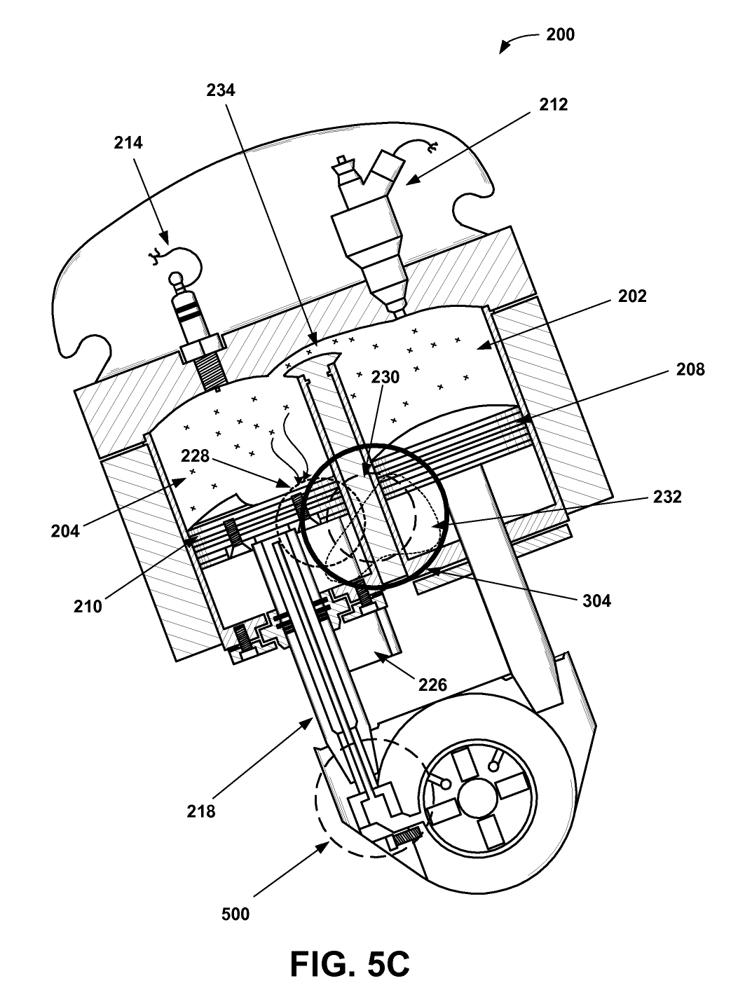

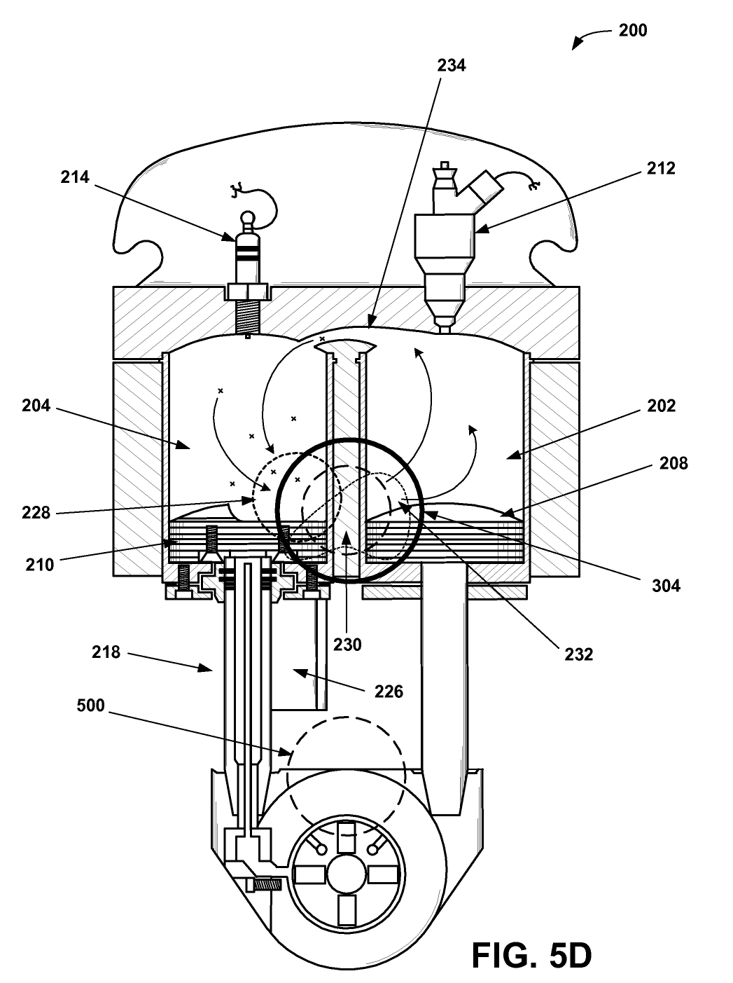

In operation 404, intake charge air is drawn in below the pistons and the intake charge air present above the pistons is compressed. FIG. 5A is a diagram showing a twin power unit 200 during a charge cycle, in accordance with an embodiment of the present invention. FIG. 5A illustrates the pistons 208/210 located in the middle of the cylinders 202/204 as they rise, when the rod base bearing mount of the rod assembly 218 is located at about 9:00 with respect to the crankshaft 500. As the pistons 208/210 begin to travel back upward, the intake charge air, forced via the upward motion of the pistons 208/210 further expels the combustion exhaust gases from the cylinders 202/204 before being compressed as the exhaust piston 210 covers the exhaust port 228. As the pistons 208/210 continue to rise, the fuel injector 212 delivers fuel to the intake cylinder 202 creating an air-fuel mixture. Because the simultaneous compression currently occurring within the top portions of the cylinders 202/204, a swirling effect is created mixing the fuel with the compressed air, creating an air-fuel mixture that also flows into the top portion of the exhaust cylinder 204 via the air-fuel crossover passage 234.

In addition, the intake piston 208 and exhaust piston 210 rise to reveal the intake charge passage 232. The rising movement of the pistons 208/210 draws in an air intake charge from the intake port 230, through the intake charge passage 232 and into the bottom portions of the cylinders 202/204 beneath the pistons 208/210. As discussed above, both the intake cylinder 202 and the exhaust cylinder 204 are fully enclosed, preventing the intake air from escaping. In addition, during operation 404 the exhaust piston skirt 226 covers the exhaust port 228, thereby preventing the intake air charge from escaping via the exhaust port 228.

Turing back to FIG. 4, the air-fuel mixture present in the top portions of the intake cylinder and exhaust cylinder above the pistons is ignited utilizing a spark plug, in operation 406. FIG. 5B illustrates a twin power unit 200 during the beginning of a power cycle, in accordance with an embodiment of the present invention. Once the pistons 208/210 reach the top of the cylinders 202/204 at 12 o'clock with respect to the crankshaft indicated at 500, the spark plug 214 ignites the compressed air-fuel mixture powering the pistons 208/210, driving the pistons 208/210 and rod assembly 218 toward the crankshaft 500. In operation 406, the compressed air-fuel mixture is present in the top portions of both cylinders 202/204, and in air-fuel crossover passage 234. Hence, spark plug 214 ignites the air-fuel mixture present in the exhaust cylinder 204, air-fuel crossover passage 234, and intake cylinder 202, resulting in both the exhaust piston 210 and the intake piston 208 being powered during the power cycle via the spark plug 214.

Referring back to FIG. 4, the combustion exhaust gasses are expelled from the exhaust cylinder as the exhaust pistons clears the top portion of the exhaust port and the intake charge air is compressed beneath the pistons, in operation 408. FIG. 5C illustrates a twin power unit 200 at the beginning of a purge cycle, in accordance with an embodiment of the present invention. The purge cycle begins as the pistons 208/210 travel downward and the exhaust piston 210 begins to clear the exhaust port 228. At this point, as illustrated in FIG. 5C, the rod base bearing mount of the rod assembly 218 is located at about 3:00 with respect to the crankshaft 500. FIG. 5C also illustrates the twin power unit's 200 rotation about the trunnion mount 304, allowing the pistons 208/210 and rod assembly 218 to follow the crankshaft 500 as it turns, without requiring a wrist pin.

During operation 408, the downward motion of the pistons 208/210 also drives the intake air present in both cylinders 202/204 below the pistons 208/210 back into the intake port 230 via the intake charge passage 232. However, the one-way reed valve present in the intake port 230 prevents the intake air from escaping out of the intake port 230. As a result, the downward motion of the pistons 208/210 compresses the intake air in the bottom portion of the cylinders 202/204 and portion of intake port 230 on the piston side of the reed valve.

In operation 410, the compressed intake air is blasted into the intake cylinder via the intake charge passage. FIG. 5D is a diagram illustrating a twin power unit 200 at the end of a purge cycle, in accordance with an embodiment of the present invention. FIG. 5D illustrates the pistons 208/210 located at the bottom of the cylinders 202/204, when the rod base bearing mount of the rod assembly 218 is located at about 6:00 with respect to the crankshaft 500. As the pistons 208/210 continue to travel downward, the intake piston 208 reveals the intake charge passage 232. The intake charge passage 232 is configured such that the intake piston 208 clears the top area of the intake charge passage 232 before the exhaust piston 210 during downward motion of the pistons 208/210. Once the top of the intake piston 208 drops below the top of the intake charge passage 232, the intake charge air compressed beneath the pistons 208/210, and in the portion of intake port 230 on the piston side of the reed valve 300, is blasted into the intake cylinder 202 above the intake piston 208. The rapid intake charge air blast purges the combustion exhaust gases from the intake cylinder 202, through the air-fuel crossover passage 234, through the exhaust cylinder 204, and out the exhaust port 228. The rapid intake charge air blast also purges the combustion exhaust gases from the air-fuel crossover passage 234 and the exhaust cylinder 204.

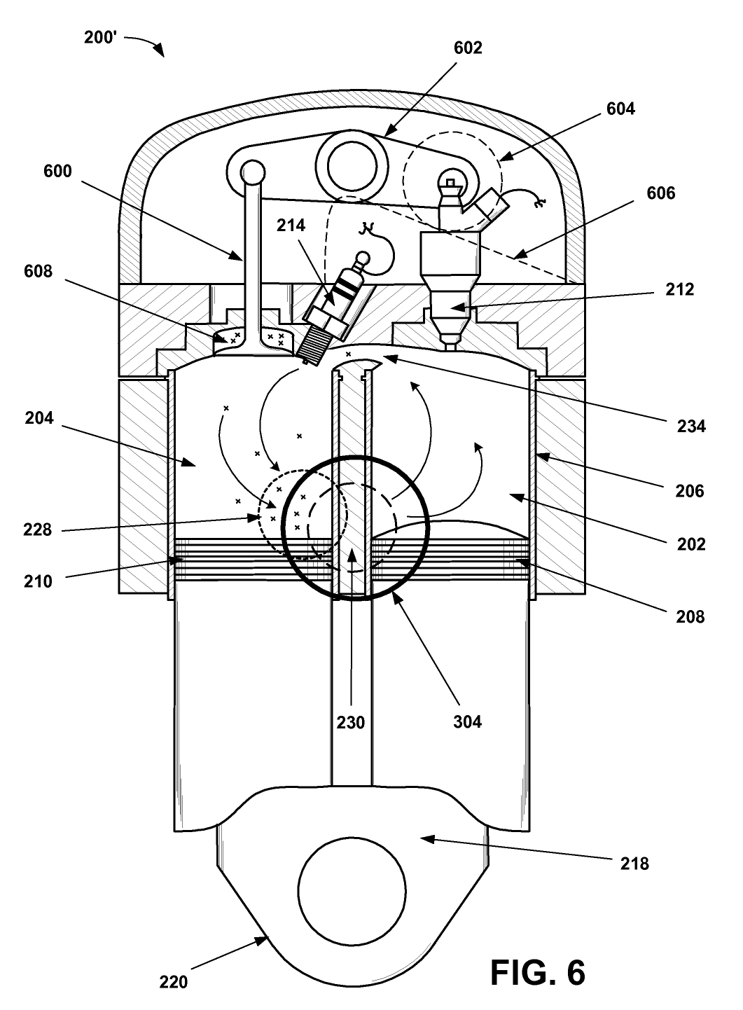

Referring back to FIG. 4, post process operations are performed in operation 412. Post process operations can include, for example, continuing with further power cycles, purge cycles, and charge cycles, and other post process operations that will be apparent to those skilled in the art after a careful reading of the present disclosure. As will be appreciated, embodiments of the present invention advantageously allow power to be applied to crankshaft without the need of a wrist pin via the trunnion mount which allows the twin power unit to oscillate. In addition, the intake charge air compression and purge allows the efficient expulsion of combustion exhaust gases without the need of an external system. Moreover, the location of the exhaust port allows the exhaust piston and exhaust piston skirt to cover the exhaust port preventing any wasteful loss of air-fuel mixture. In addition, to utilizing compressed intake charge air beneath the pistons during the purge cycle, embodiments of the present invention can further utilize uncompressed intake air combined with an exhaust valve to provide combustion exhaust gas purging, as illustrated next with reference to FIG. 6.

FIG. 6 is a diagram showing an oscillating cylinder twin power unit 200″ for an internal combustion engine utilizing an exhaust valve 600 and rocker assembly 602 for purging combustion exhaust gases, in accordance with an embodiment of the present invention. The exemplary twin power unit 200″ of FIG. 6 includes an intake cylinder 202 and exhaust cylinder 204, each enclosing a piston sleeve 206 and connected via an air-fuel crossover passage 234. Located in the intake cylinder 202 is an intake piston 208, and disposed in the exhaust cylinder 204 is an exhaust piston 210. A fuel injector 212 is situated above the intake cylinder 202 and a spark plug 214 is located above and off center of the exhaust cylinder 204. Fixed below the pistons 208 and 210 is a rod assembly 218, which includes a rod base bearing mount 220. An exhaust port 228 out of the exhaust cylinder 204 and an intake port 230 providing air to the intake cylinder 202 also are included. In addition, an exhaust valve 600 is located above the exhaust cylinder 204 and is utilized to control the flow of combustion exhaust gas through the exhaust valve port 608. The exhaust valve 600 is moveably attached to a rocker assembly 602, which is further coupled to a rocker roller 604. The rocker roller 604 rest on a ramp cam 606 and moves along the ramp cam 606 during operation, as will be described subsequently.

Similar to the embodiment of FIG. 2A, oscillating cylinder twin power unit 200″ of FIG. 6 functions utilizing a power cycle, purge cycle, and charge cycle. The power cycle begins when the intake piston 208 and the exhaust piston 210 reach the top of the cylinders 202/204 and full compression is achieved. This occurs when the rod assembly 218 is at approximately 12 o'clock with respect to the crankshaft. The spark plug ignites the compressed air-fuel mixture powering the both pistons 208/210 and driving the pistons 208/210 and rod assembly 218 toward the crankshaft. As mentioned previously, during full compression, the compressed air-fuel mixture is present in the top portions of both the intake cylinder 202 and the exhaust cylinder 204, and also in air-fuel crossover passage 234. Hence, the spark plug 214 ignites the air-fuel mixture in the exhaust cylinder 202, which ignites the air-fuel mixture in the air-fuel crossover passage 234, which ignites the air-fuel mixture in the intake cylinder 202. As a result, both the exhaust piston 210 and the intake piston 208 are powered during the power cycle via the spark plug 214.

The purge cycle begins as the pistons 208 and 210 travel downward within the cylinders 202/204 and the twin power unit 200′ begins to pivot about the trunnion mount 304 allowing the rod assembly 218 and pistons 208/210 to follow the rotation of the crankshaft via the crank journal. As the twin power unit 200″ pivots about the trunnion mount 304, the rocker roller 604 begins to roll up the ramp cam 606. The ramp cam 606 is mounted outside the twin power unit 200″ and remains in a fixed position as the twin power unit 200″ pivots. The rocker roller 604 is coupled to the rocker assembly 602, which is attached to the twin power unit 200″. Hence, as the twin power unit 200′ pivots, the rocking motion of the twin power unit 200′ causes the rocker roller 604 to roll back and forth along the ramp cam 606. As the rocker roller 604 rolls up the ramp cam 606, the attached rocker assembly 602 causes the exhaust valve 600 to open. Then, as the rocker roller 604 rolls back down the ramp cam 606, caused by the twin power unit 200′ pivoting in the opposite direction, the attached rocker assembly 602 allows the exhaust valve 600 to close.

In this manner, when the rod assembly 218 is located at about 3:00 with respect to the crankshaft, and the pistons 208/210 have traversed approximately half the distance to their bottom most position, the rocker roller 604 is positioned on the ramp cam 606 such that the rocker assembly 602 causes the exhaust valve 600 to open. The opening of the exhaust valve 600 allows the combustion exhaust gases in the upper portion of the cylinders 202/204 to escape the cylinders 202/204. In addition, as the pistons 208/210 continue travel downward within the cylinders 202/204, the exhaust the exhaust piston 210 begins to clear the exhaust port 228 when the rod assembly 218 reaches about 4:00 with respect to the crankshaft, allowing additional combustion exhaust gases to escape.

The charge cycle begins as the pistons travel further downward and the intake piston 208 begins to clear the intake port 230. At this point, a blower blast intake charge air into the intake cylinder 202 above the intake piston 208. The intake blast air helps purge the remaining combustion exhaust gases present in both the intake cylinder 202 and the exhaust cylinder 204. A bellows charges intake air through the intake port 230, up the intake cylinder 202, through the air-fuel crossover passage 234, and out the exhaust cylinder 204 through the exhaust port 228 and the past the open exhaust valve port 608. As can be appreciated, the twin power unit 200″ of FIG. 6 uses slightly overlapping cycles, in that the purge cycle and charge cycle overlap to some extent. This continues as the pistons 208/210 reach their bottom most positions within the cylinders 202/204. The charge cycle and purge cycle continue as the pistons rise until the exhaust piston 210 covers the exhaust port 228 and the intake piston 208 covers the intake port 230. This occurs approximately when the rod assembly 218 reaches about 8:00 o'clock with respect to the crankshaft. At this time the rocker roller 604 rolls back down the ramp cam 606 causing the rocker assembly 602 to allow the exhaust valve 600 to close the exhaust valve port 608.

Compression starts when the rod assembly 218 reaches about 9:00 o'clock with respect to the crankshaft and the fuel injector 212 injects fuel into the intake cylinder 202. The intake charge air coupled with the compression from the rising pistons 2058/210 causes the fuel to efficiently mix with the compressed intake air charge creating an air-fuel mixture. In addition, part of the air-fuel mixture in the intake cylinder 202 flows into the air-fuel crossover passage 234 and into the exhaust cylinder 204, which at this point has all exhaust ports closed. Once the pistons 208/210 reach their top most positions within the cylinders 202/204, another power cycle begins with the spark plug 214 igniting the air-fuel mixture present in both cylinders 202/204 and the air-fuel crossover passage 234.

As those skilled in the art will appreciate after a careful reading of the present disclosure, embodiments of the present invention provide power on each revolution of the crankshaft. Moreover, the trunnion mount allows the twin power unit to oscillate back and forth across a small arc while tracking the rotational movement of the point of contact between the base on the rod assembly and the crankshaft. Hence, trunnion mount allows the twin power unit to oscillate such that the centerline of the pistons is at all times aligned with the crank throw of the crankshaft to eliminate lateral force vectors. The rigid fixed-length rod assembly connecting the pistons to the crankshaft causes the cylinders to oscillate while the pistons rotate semi-elliptically in their motion to turn the crankshaft. Since the rod assembly directly connects the pistons to the crankshaft, there is no need for a wrist pin and connecting rod. Furthermore, the below piston compressed intake air charge and reed valve design of the embodiment of FIG. 2 allows significant charging and purging of the cylinders without requiring outside assistance.

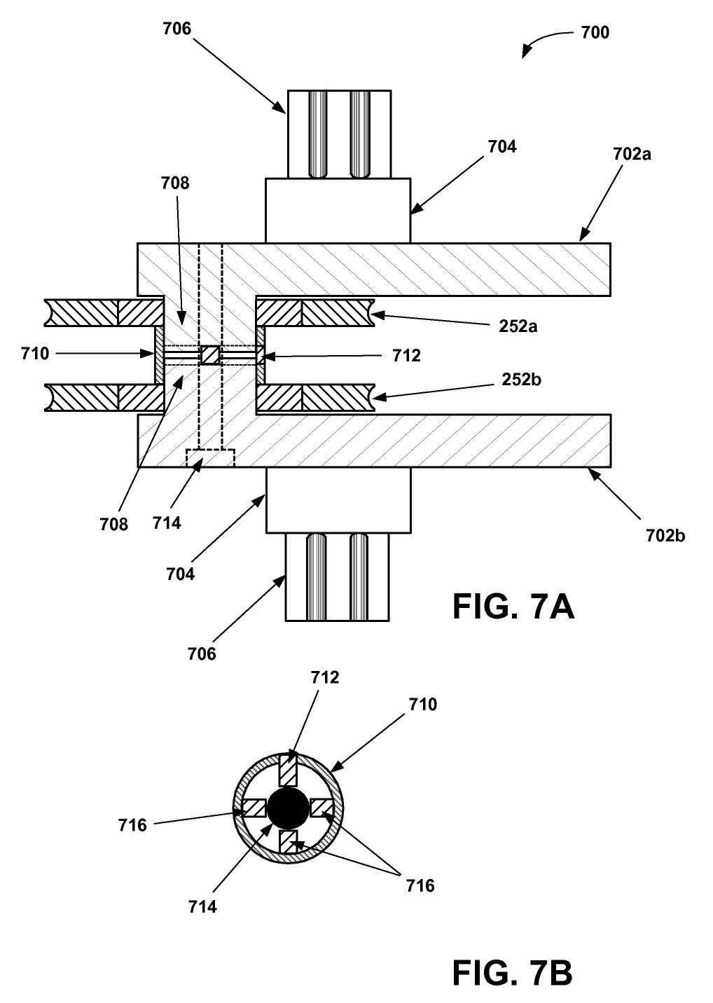

FIG. 7A is schematic diagram illustrating a crank assembly 700 comprising two crank halves 702a and 702b, in accordance with an embodiment of the present invention. More specifically the crank assembly 700 includes crank halves 702a and 702b, each including a main journal portion 704 and a splined crank coupler 706. Although FIG. 7A illustrates a crank assembly 700 wherein each crank half 702a/702b includes a splined crank coupler 706, it should be borne in mind that either crank half 702a/702b could include a main journal portion 704 without a splined crank coupler 706, depending on the position of the particular power unit within a tandem engine. Each crank half 702a/702b further includes a crank throw portion 708. Surrounding the crank throw portions 708 of each crank half 702a/702b is a crank throw journal sleeve 710, which includes a locking keyway pin 712 positioned to hold the crank throw journal sleeve 710 in place. A bolt 714 holds the crank halves 702a/702b together.

The crank assembly 700 of the embodiments of the present invention can advantageously be separated by removing the bolt 714 holding the crank halves 702a/702b together. To reassemble the crank assembly 700 the crank throw portions 708 of each crank half 702a/702b are positioned together and held in place using the crank throw journal sleeve 710. The bolt 714 can then be reinserted to bolt the crank halves 702a/702b together. As illustrated in FIG. 7A, the two crank throw portions 708 and crank throw journal sleeve 710 portions for a crank throw journal around which is positioned the racking rollers 252a and 252b, which guide the pistons along the guide rails of the cylinder control arms.

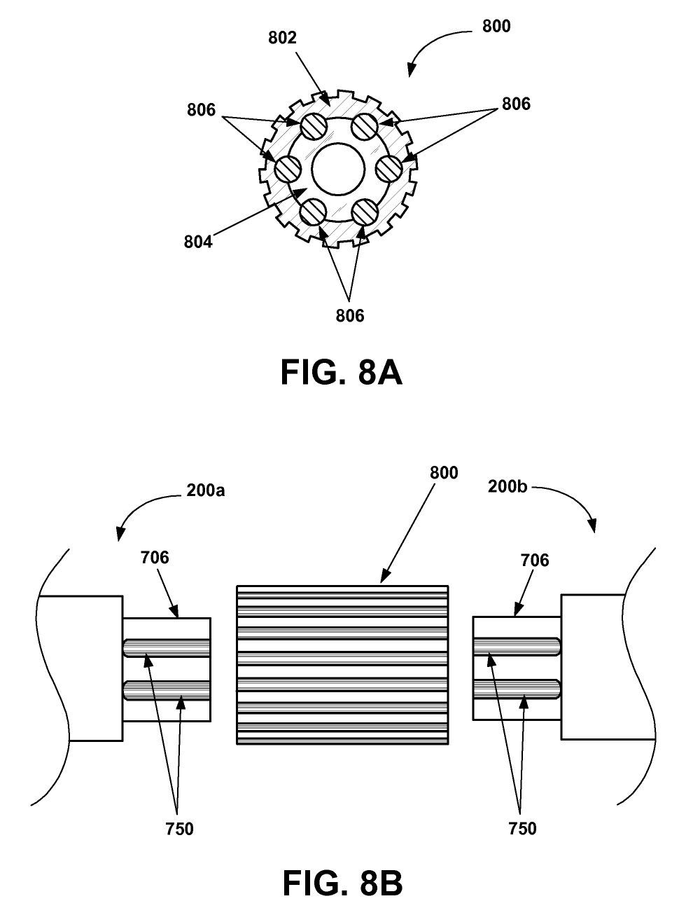

FIG. 7B is schematic diagram illustrating a crank throw journal sleeve 710 and supporting keyway pins 716, in accordance with an embodiment of the present invention. When set in position around the crank throw portions 708 of the crank halves 702a/702b, the keyway pins 716 help to keep the crank throw journal aligned during operation. In addition, as mentioned above, the locking keyway pin 712 holds the crank throw journal sleeve 710 in place. More specifically, the locking keyway pin 712 includes a rounded end that locks into a hole in the crank throw journal sleeve 710 and prevents the crank throw journal sleeve 710 from turning as the crank rotates during operation. The crank couplers 706 are utilized to connect two power units together using a crank coupler assembly to form a tandem engine, as described next with reference to FIGS. 8A and 8B.

FIG. 8A is a schematic diagram showing a front view of crank coupler assembly 800, in accordance with an embodiment of the present invention. In one embodiment, the crank coupler assembly 800 includes an outer drive portion 802 and a center divider 804 that holds a plurality of hardened pins 806 in position. In use, the hardened pins 806 are positioned to fit along the splines of the crank coupler portions of two power units, while the center divider 804 functions to assist in alignment.

FIG. 8B is a diagram showing splined crank coupler portion 706 from two power units 200a and 200b prior to being attached together via the crank coupler assembly 800, in accordance with an embodiment of the present invention. As illustrated in FIG. 8B, the crank coupler assembly 800 joins together power units by sliding onto the crank coupler portion 706 of each power unit. In doing so, the hardened pins 806 of the crank coupler assembly 800 fit into the slots 750 of each splined crank coupler portion 706. Once connected, the outer drive portion 802 of the crank coupler assembly 800 allows the crank coupler assembly 800 to be used as either a belt or chain drive, in which case the crank coupler assembly 800 can function as a sprocket.

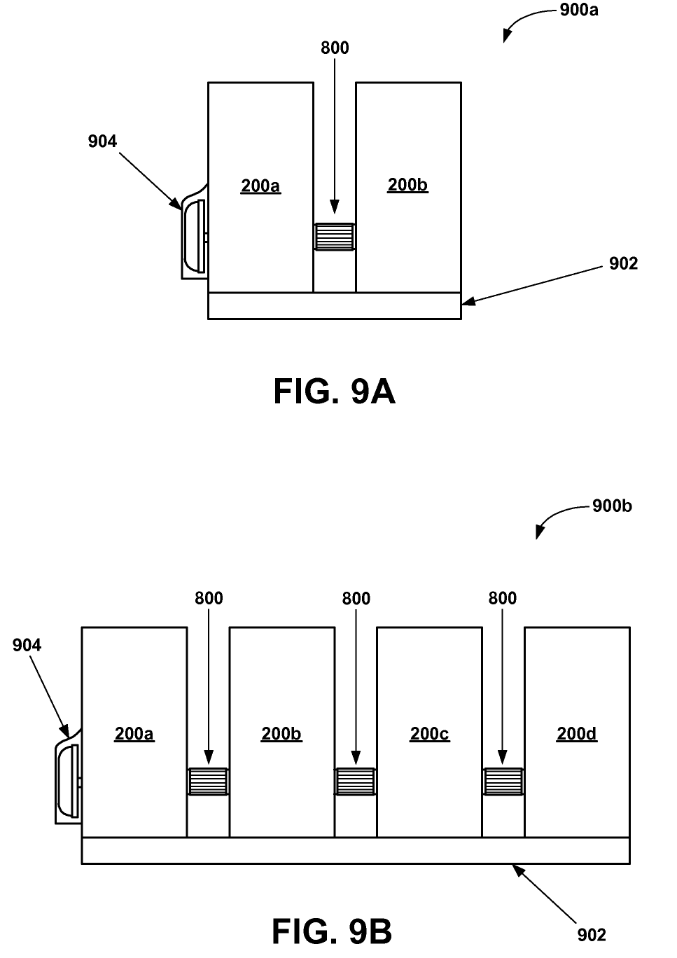

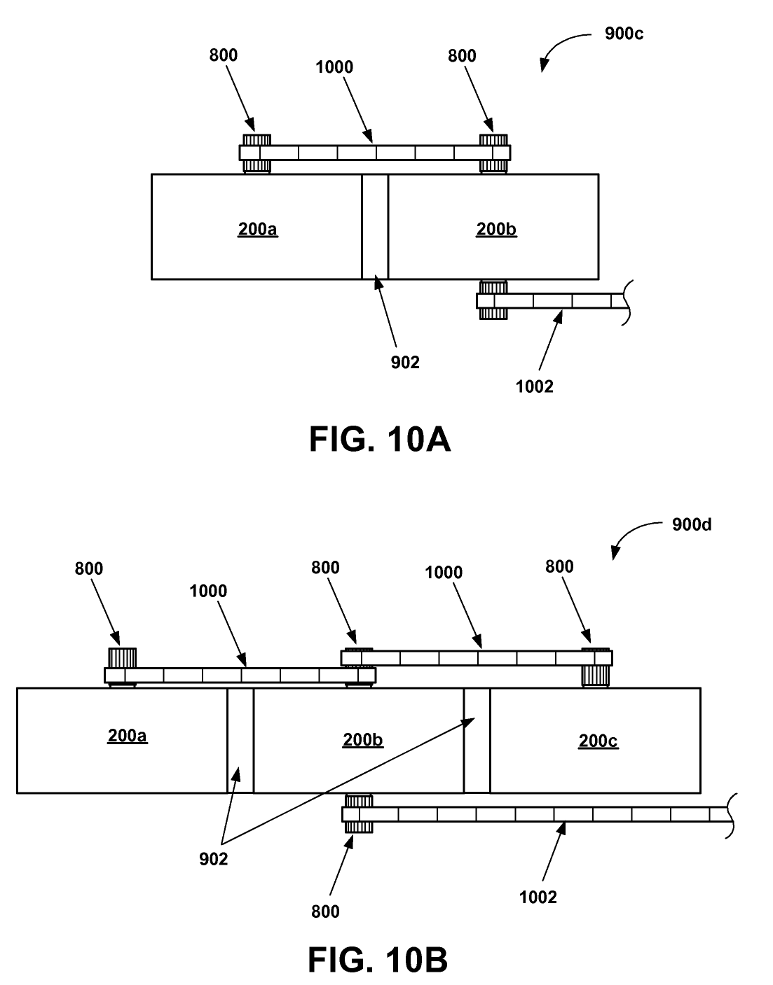

Referring back to FIG. 8A, the number of hardened pins 806 included in a crank coupler assembly can be related to the number of cylinders that are to be included in a tandem engine to help align each power unit's rotational crank throw journal position correctly with the other power units. For example, when used with a six-cylinder tandem engine, six hardened pins 806 can be included in each crank coupler assembly 800 situated to align the crank throw journal of each power unit 120° degrees from adjacent power unit crank throw journals. Similarly, when used with a four-cylinder tandem engine, four hardened pins 806 can be included in each crank coupler assembly 800 situated to align the crank throw journal of each power unit 180° from the adjacent power unit crank throw journal. In this manner, crank coupler assemblies 800 can be utilized to form tandem engines, as described next with reference to FIGS. 9A-10B.

FIG. 9A is a diagram showing a side view of an exemplary four-cylinder tandem engine 900a, in accordance with an embodiment of the present invention. The four-cylinder tandem engine 900a of FIG. 9A includes two power units 200a and 200b disposed on a base 902 and coupled together via a crank coupler assembly 800. The four-cylinder tandem engine 900a of FIG. 9A further includes a fly wheel and clutch assembly 904. As described above, the crank coupler assembly 800 couples together power units 200a and 200b via the splined crank coupler section on each crank half. Specifically, the splined crank coupler section of each crank half slides into the crank coupler assembly 800, coupling the two power units 200a and 200b together to form a four-cylinder tandem engine 900a. The crank coupler assembly 800 couples the crank halves of the two power units 200a and 200b together to form a “crank shaft.” In this manner, any number of power units can be coupled together to form tandem engines of various sizes, such as an eight-cylinder tandem engine as illustrated in FIG. 9B.

FIG. 9B is a diagram showing a side view of an exemplary eight-cylinder tandem engine 900b, in accordance with an embodiment of the present invention. The eight-cylinder tandem engine 900b includes eight power units 200a-200d disposed on a base 902 and coupled together via a plurality of crank coupler assemblies 800. As above, the eight-cylinder tandem engine 900b includes a fly wheel and clutch assembly 904. Similar to FIG. 9A, each crank coupler assembly 800 in FIG. 9B couples together two power units via the splined crank coupler section on each crank half, thus forming a “crank shaft” driving by the power units 200a-200d.

In one embodiment, the transmission can include a bell housing such that a tandem engine as described above can be joined to the transmission utilizing a crank coupler assembly 800 in a manner similar to coupling together two power units. In this embodiment, each transmission bell housing can include a fly wheel and clutch assembly that 904 includes a splined crank coupler section capable of being coupled to a power unit via a crank coupler assembly 800. Moreover, as mentioned previously, the outer drive portion 802 of the crank coupler assembly 800 allows the crank coupler assembly 800 to be used as a belt or chain drive, allowing inline tandem engines as illustrated in FIGS. 10A and 10B.

FIG. 10A is a diagram showing a top view of an exemplary four-cylinder inline tandem engine 900c, in accordance with an embodiment of the present invention. The four-cylinder inline tandem engine 900c of FIG. 10A includes two power units 200a and 200b disposed side by side on a base 902 and coupled together via a belt 1000 and two crank coupler assemblies 800. As above, each crank coupler assembly 800 is attached to a splined crank coupler section of the operable crank half of each power unit 200a and 200b. In addition, a belt 1000 is positioned around each crank coupler assembly 800, coupling the two power units 200a and 200b together. A further belt 1002 is positioned around an additional crank coupler assembly 800 on power unit 200b to couple power unit 200b to a fly wheel and clutch assembly (not shown). Although FIG. 10A has been described in terms of belt usage, it should be borne in mind that other coupling means can be utilized to couple the power units, such as a chain. Similar to above, using belts 1000 and crank coupler assemblies as illustrated in FIG. 10A, any number of power units can be coupled together to form inline tandem engines of various sizes, such as a six-cylinder tandem engine as illustrated in FIG. 10B.

FIG. 10B is a diagram showing a top view of an exemplary six-cylinder inline tandem engine 900d, in accordance with an embodiment of the present invention. The six-cylinder inline tandem engine 900d includes three power units 200a-200c disposed side by side on a base 902 and coupled together via belts 1000 and crank coupler assemblies 800. As above, each crank coupler assembly 800 is attached to a splined crank coupler section of the operable crank half of each power unit 200a-200c. In addition, belts 1000 are positioned around each crank coupler assembly 800, coupling the three power units 200a-200c together. A further belt 1002 is positioned around an additional crank coupler assembly 800 on power unit 200b to couple power unit 200b to a fly wheel and clutch assembly (not shown). As mentioned above, it should be borne in mind that other coupling means can be utilized to couple the power units, such as chains.

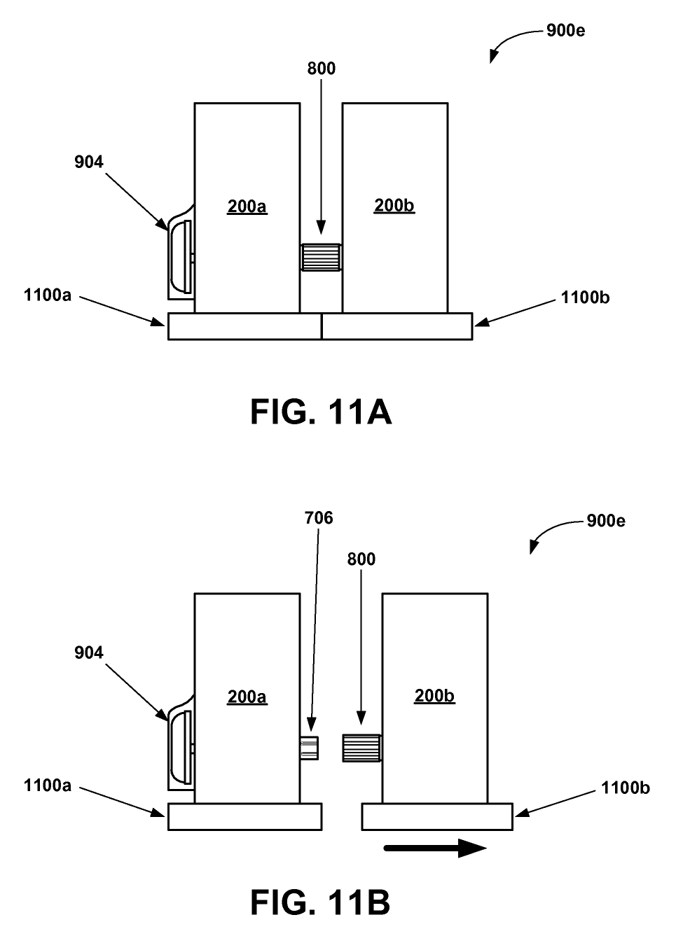

FIG. 11A is a diagram showing a side view of an exemplary decoupling four-cylinder tandem engine 900e, in accordance with an embodiment of the present invention. The decoupling four-cylinder tandem engine 900e of FIG. 11A includes two power units 200a and 200b each disposed on separate decoupling bases 1100a and 1100b. During idle and at low starting speeds the two power units 200a and 200b are coupled together via a crank coupler assembly 800, similar to the four-cylinder tandem engine 900a of FIG. 9A. However, as the vehicle increases in speed and no longer requires the torque provided by power unit 200b, the decoupling four-cylinder tandem engine 900e has the ability to save fuel by decoupling power unit 200b, as illustrated in FIG. 11B.

FIG. 11B is a diagram showing a side view of the exemplary decoupling four-cylinder tandem engine 900e after decoupling, in accordance with an embodiment of the present invention. As mentioned above, once the additional torque provided by power unit 200b is no longer needed, the decoupling four-cylinder tandem engine 900e separates. More specifically, the base 1100b upon which rests power unit 200b moves away from the base 1100a upon which rests power unit 200a. As a result, the crank coupler assembly 800 slides off the crank coupler 706 of power unit 200a, thus separating power unit 200a from power unit 200b. Once separated, power unit 200a can operate separately to power the vehicle as a two-cylinder engine, while power unit 200b can be turned off in order to save fuel. Later, during idle, the power units 200a and 200b can be coupled together again by moving base 1100b back toward base 1100a. This action results in the crank coupler assembly 800 sliding back onto the crank coupler 706 of power unit 200a, thus reconnecting the power units 200a and 200b to function as a complete four-cylinder engine again. Similar to above, any number of power units can be coupled together to form decoupling tandem engines of various sizes, such as an eight-cylinder tandem engine that decouples between the second and third power units to operate as a four-cylinder engine when decoupled.

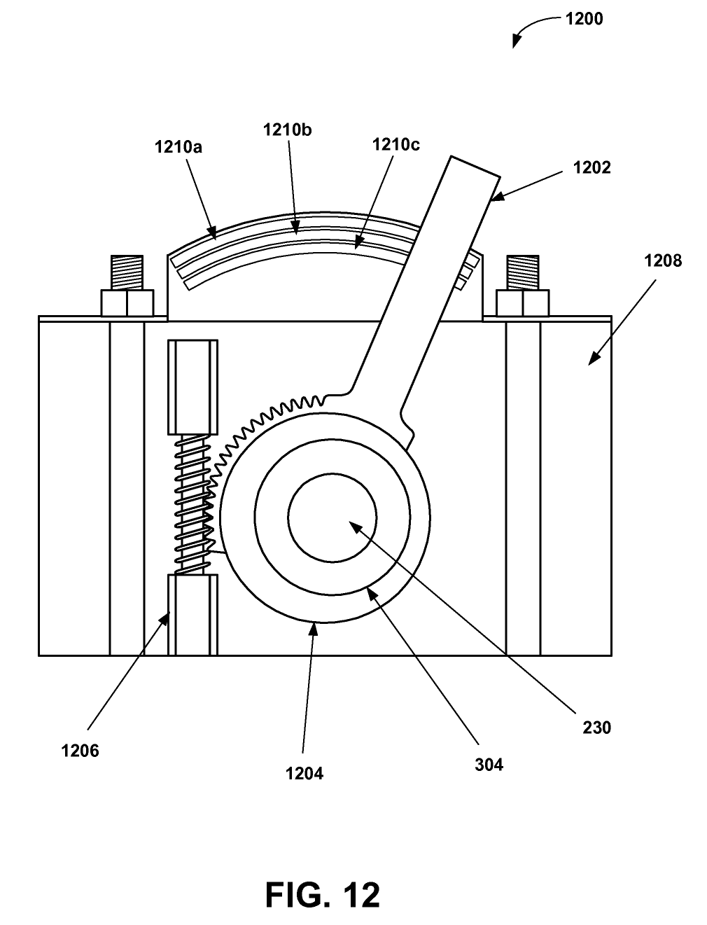

FIG. 12 is a diagram showing an exemplary variable compression power unit 1200 having cylinder compression variance capability, in accordance with an embodiment of the present invention. The variable compression power unit 1200 is a power unit similar to those described above with reference to FIG. 2A-5D and includes, for example, an intake port 230 disposed within a trunnion mount 304. In addition, the variable compression power unit 1200 includes elements that enable the cylinder compression to be adjusted to enhance engine performance. For example, the exemplary variable compression power unit 1200 of FIG. 12 includes a compression selection handle 1202 connected to a compression selector ring 1204, which is positioned around the trunnion mount 304. The selector ring 1204 also is connected to the engine case place 1208.

As can be seen in FIG. 12, the trunnion mount 304 is situated off-center from the center of the compression selector ring 1204. That is, the center of the trunnion mount 304 is offset from the center of the compression selector ring 1204. For example, in FIG. 12 the center of the trunnion mount 304 is offset to the right from the center of the compression selector ring 1204 when the compression selector handle 1202 is disposed to the right of center. In this manner, when the compression selector handle 1202 is moved to left of center, the trunnion mount 304 travels slightly toward the top of the power unit 1200. The movement of the trunnion mount 304 causes the power unit cylinders to move in the same direction because, as noted above, the power unit cylinders are connected to the trunnion mount 304. However, the pistons are not connected to the trunnion mount.

As a result, when the compression selector handle 1202 is moved to left of center causing the trunnion mount 304 and the power unit cylinders move slightly upward, more space is provided between the top of the pistons and the top of the cylinders during compression. Conversely, when the compression selector handle 1202 is moved to right of center causing the trunnion mount 304 and the power unit cylinders move slightly downward, less space is provided between the top of the pistons and the top of the cylinders during compression.

In one embodiment, a worm drive shaft 1206 is provided to mechanically move the compression selector handle 1202 from right of center to left of center and vice versa. In this embodiment, teeth are included on the compression cylinder handle 1202 as illustrated in FIG. 12, and disposed between the external threads of the worm drive shaft 1206. During operation, the worm drive shaft 1206 is rotated in a first direction to cause the compression selector handle 1202 to move from right of center to left of center. The worm drive shaft 1206 can be rotated in the opposite direction to cause the compression selector handle 1202 to move from left of center to right of center.

For example, during normal running of the power unit 1200, the worm drive shaft 1206 is used to move the compression selector handle 1202 to left of center, thus allowing more space between the top of the cylinders and the top of the pistons. During idle, additional compression can be achieved by using the worm drive shaft 1206 to move the compression selector handle 1202 to right of center, thus reducing the space between the top of the cylinders and the top of the pistons and increasing compression.

Contacts can be included to allow the compression selector handle 1202 to signal when particular plugs or injectors should be used. For example, the exemplary variable compression power unit 1200 includes a hot plug selector contact 1210a, cold plug selector contact 1210b, and an injector selector contact 1210c. During operation, when the compression selector handle 1202 is positioned to right of center, the hot plug selector contact 1210a is contacted and the hot spark plug is used for spark. Similarly, when the compression selector handle 1202 is positioned to left of center, the cold plug selector contact 1210b is contacted and the cold spark plug is used for spark. In addition, based on the position of the compression selector handle 1202, injector performance can be controlled. Hence, power from the engine can come from fuel and/or compression. In addition, a tandem engine can include a leveling device that increases compression when the vehicle travels up hill, thus burning more fuel and providing more power. Similarly, the compression also can be increased when traveling down a long grade.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. An internal combustion engine power unit in tandem, comprising:
a parallel cylinder assembly perpendicular to a crank, the parallel cylinder assembly having an intake cylinder in fluid communication with an intake trunnion port and an exhaust cylinder connected to an exhaust trunnion port;
cylinder arms extending down to crank rollers that roll up and down arm guides as a crank throw rotates, oscillating the parallel cylinder assembly on trunnions back and forth;
a parallel piston rod assembly movable within the parallel cylinder assembly perpendicular at one end while being held by rod journal at another end, wherein the parallel piston rod assembly moves in an elliptical motion when swinging on the trunnions and moving in the parallel cylinder assembly; and
a crank assembly movably attached to the parallel piston rod assembly via a crank throw portion, the crank assembly further connected to a main journal.

2. An internal combustion engine power unit, comprising:
a cylinder assembly comprising an intake cylinder and an exhaust cylinder, the cylinder assembly connected to a trunnion allowing the cylinder assembly to oscillate;
a parallel piston rod assembly having a first end and a second end, wherein the first end is movable within the cylinder assembly; and
a crank assembly movably attached to the parallel piston rod assembly via a crank throw portion, the crank assembly further connected to a main journal.

3. An internal combustion engine power unit as recited in claim 2, further including a crank coupler attached to the main journal, the crank coupler being capable of being further attached to a second main journal of a second internal combustion engine power unit, whereby a tandem internal combustion engine is formed.

4. An internal combustion engine power unit as recited in claim 2, further comprising a plurality of cylinder control arms for facilitating piston movement within the cylinder assembly.

5. An internal combustion engine power unit as recited in claim 4, further including a plurality of racking rollers movably attached to a crank throw portion, the racking rollers capable of moving along the cylinder control arms for facilitating piston movement within the cylinder assembly.

6. An internal combustion engine power unit as recited in claim 2, wherein the trunnion comprises an air intake trunnion in fluid communication with the intake cylinder and the exhaust cylinder beneath pistons disposed within the cylinders, and an exhaust trunnion in fluid communication with an exhaust cylinder port during a purge stroke of the engine.

7. An internal combustion engine power unit as recited in claim 2, further comprising an air fuel mixing chamber having a spark plug between parallel cylinder tops and further having a restricted outlet.

8. An internal combustion engine power unit as recited in claim 2, further comprising a vertical worm drive mounted in case plates turning side trunnions for eccentric movement, for high or low compression.

9. A tandem internal combustion engine, comprising:
a first power unit having an enclosed intake cylinder, an enclosed exhaust cylinder and two pistons each disposed within an enclosed cylinder, wherein each piston compresses air beneath the piston before the compressed air is transferred to the intake cylinder, the first power unit further including a main journal attached to a crank coupler;
a second power unit having an enclosed intake cylinder, an enclosed exhaust cylinder and two pistons each disposed within an enclosed cylinder, wherein each piston compresses air beneath the piston before the compressed air is transferred to the intake cylinder, the second power unit further including a main journal attached to a crank coupler; and
a crank coupler assembly in physical communication with the crank coupler of the first power unit and the crank coupler of the second power unit.

10. A tandem internal combustion engine as recited in claim 9, wherein the crank coupler of the first power unit and the crank coupler of the second power unit have splined shafts.

11. A tandem internal combustion engine as recited in claim 10, wherein the crank coupler assembly includes a plurality of hardened pins positioned to fit splines of the splined shafts of the crank couplers.

12. A tandem internal combustion engine as recited in claim 9, wherein each power unit includes a crank assembly comprising two crank halves coupled together via a bolt, each crank half being attached to a main journal.

13. A tandem internal combustion engine as recited in claim 12, wherein each crank half includes a crank throw portion, and wherein a sleeve surrounds the crank throw portion of each crank half of a crank assembly.

14. A tandem internal combustion engine as recited in claim 13, wherein a plurality of keyway pins is disposed within the sleeve, and wherein one keyway pin is attached to the sleeve.

15. A tandem internal combustion engine as recited in claim 9, wherein the first power unit is separated from the second power unit when the tandem internal combustion engine is at idle.

16. A tandem internal combustion engine, comprising:
a first power unit having an enclosed intake cylinder, an enclosed exhaust cylinder and two pistons each disposed within an enclosed cylinder, wherein each piston compresses air beneath the piston before the compressed air is transferred to the intake cylinder, the first power unit further including a main journal attached to a crank coupler and a crank coupler assembly in physical communication with the crank coupler;
a second power unit having an enclosed intake cylinder, an enclosed exhaust cylinder and two pistons each disposed within an enclosed cylinder, wherein each piston compresses air beneath the piston before the compressed air is transferred to the intake cylinder, the second power unit further including a main journal attached to a crank coupler and a crank coupler assembly in physical communication with the crank coupler; and
a coupling means that couples the crank coupler assembly of the first power unit to the crank coupler assembly of the second power unit.

17. A tandem internal combustion engine as recited in claim 16, wherein the coupling means is a belt.

18. A tandem internal combustion engine as recited in claim 16, wherein the coupling means is a chain.

19. A tandem internal combustion engine as recited in claim 16, wherein each power unit includes a plurality of cylinder control arms, each cylinder control arm including a guide rail portion capable of guiding the movement of the pistons of the power unit during operation.

20. A tandem internal combustion engine as recited in claim 19, wherein the movement of the pistons of each power unit is guided utilizing a rolling means affixed to crank throw that rolls up and down along the guide rails as crank rotates.
